(19) United States
(12) Patent Application Publication
(10) Pub. No.: US 2024/0043331 A1
(43) Pub. Date: Feb. 8, 2024

(54) NO ADDED FORMALDEHYDE COMPOSITIONS, COMPOSITE PRODUCTS AND METHODS OF MAKING AND USING THE SAME

(71) Applicant: Arclin USA LLC, Roswell, GA (US)

(72) Inventors: Arun Narayan, Duluth, GA (US); Samuel Walter Lonberg, Fuquay Varina, NC (US); Morgan Higgins, Holly Springs, NC (US); Guillermo Jose Velarde, Cary, NC (US); Teong Tan, Alpharetta, GA (US)

(73) Assignee: Arclin USA LLC, Roswell, GA (US)

(21) Appl. No.: 18/364,276

(22) Filed: Aug. 2, 2023

Related U.S. Application Data
(60) Provisional application No. 63/370,181, filed on Aug. 2, 2022.
(60) Provisional application No. 63/370,161, filed on Aug. 2, 2022.
(60) Provisional application No. 63/370,175, filed on Aug. 2, 2022.

(51) Int. Cl. C04B 28/00; C04B 18/14; C04B 14/04; C04B 14/28; C04B 24/30; C04B 38/10; B32B 21/08

(52) U.S. Cl. CPC C04B 28/006; C04B 18/146; C04B 14/041; C04B 14/28; C04B 24/30; C04B 38/10; B32B 21/08; C04B 2111/28

(57) ABSTRACT

No added formaldehyde (NAF) compositions and composite products are provided. Geopolymer-based compositions, composite products with improved fire retardant properties and methods of making and using the same are also provided.

### CROSS REFERENCE TO RELATED APPLICATIONS

This application claims priority to and benefit of U.S. Provisional Application No. 63/370,161, filed on Aug. 2, 2022, 63/370,175, filed on Aug. 2, 2022, and 63/370,181, filed on Aug. 2, 2022, all of which are incorporated by reference in their entirety.

### FIELD OF THE INVENTION

Embodiments described herein generally relate to no added formaldehyde (NAF) compositions and composite products. More particularly, such embodiments relate to geopolymer-based compositions, methods of making and using the same, and the composite products.

### BACKGROUND OF THE INVENTION

Formaldehyde is considered a probable human carcinogen, as well as an irritant and allergen, and its use has increasingly restricted in building products, along with textiles, saturated paper overlays, automotive, airline or transport, fiber reinforced plastics (FRP) and other specialty market applications. In response, binder compositions have been developed that reduce or eliminate formaldehyde from the binder composition. The potentially carcinogenic effects of formaldehyde and the environmental sustainability of petroleum-based polymer feedstock's, new binder materials have to be considered. In addition, there are increasing concerns about the toxicity of chemicals in the environment, including flame retardants. Recently, halogen containing flame retardants have especially come under attack since their presence has been found to be increasing in the environment. For example, several of the polybromo diphenyloxides (PBDO) have already been banned from use. For example, the most durable phosphorus containing flame retardant systems available for cellulosic substrates require formaldehyde to “insolublize” the flame retardant materials for durability. Thus, there is a need for formaldehyde-free flame retardant compositions that double up as formaldehyde free binders/adhesives that impart good physical properties to the end product or market application in question.

Therefore, it is an object of the invention to provide no added formaldehyde compositions and composite products.

It is another object of the invention to provide geopolymer-based compositions and composite products.

It is still another object of the invention to provide compositions and composite products with improved fire retardant properties and improved mechanical properties.

It is also object of the invention to provide drastically improved geopolymer-based finished product properties with zero emissions.

It is further object of the invention to provide new geopolymers, and binder systems that can be used as the novel no emissions/no-added formaldehyde resin system that performs better than incumbent technology and can potentially be a good moisture barrier.

These needs and other needs are met by the various aspects of the present disclosure.

### SUMMARY OF THE INVENTION

Geopolymer-based compositions, methods of making and using the same are provided. Composite products prepared from geopolymer compositions are also provided.

In some embodiments, a geopolymer composition, can include a metakaolin; an alkali silicate in a solvent; and at least one filler.

In further embodiments, a method for preparing a wood composite product, can include contacting a plurality of wood substrates with a geopolymer composition, wherein the geopolymer composition can include a metakaolin; an alkali silicate in a solvent; and at least one filler; and curing the composition at a temperature of about 25° C. to about 250° C. and at a pressure of about 100 psi to about 5000 psi to produce a wood composite product.

In other embodiments, a wood composite product, can include a plurality of wood substrates; and at least cured geopolymer composition, wherein the geopolymer composition can include a metakaolin; an alkali silicate in a solvent; and at least one filler.

In some embodiments, a method for preparing a particle board, can include loading a wood furnish into a blender; applying a geopolymer composition to the wood furnish via atomized spray; placing the wood furnish in a 12″×12″ mold via felting process to form a molded panel; unmolding the molded panel via pre-pressing with body weight pressure to form a pre-press panel; placing a wax paper over the pre-pressed panel in order to prevent sticking to the heated press; curing the panel at a temperature of about 180° F. to about 300° F. for about 5 minutes to about 1 hour and at a pressure of about 1 psi to about 500 psi; pressing the warm panel together under 18-50 lb weights via hot stacking process; and heating the panel at a temperature of about 180° F. in an oven for about 1 hour to about 4 hours to produce the particle board.

In other embodiments, a method for preparing a plywood, can include applying a geopolymer composition to a plywood veneer on both faces via roller, wire round metering rod, slot die coater, doctor blade, or paint brush; placing the veneer faces together in perpendicular fashion with respect to wood grain; pressing the veneer faces at a temperature of about 180° F. to about 250° F. for about 5 minutes to about 30 minutes at a pressure of about 1,500 psi to form a plywood construct; removing the plywood construct from pressed condition; and placing the plywood construct under 80 lb weight for 48 hours at room temperature to form the plywood.

In some embodiments, a refractory brick composition, can include a plurality of brick substrates; and a geopolymer composition, wherein the geopolymer composition can include a metakaolin; a metal silicate in a solvent; and at least one filler.

In other embodiments, a method for preparing a refractory brick, can include loading a plurality of brick substrates; applying a geopolymer composition to the brick substrates to form a mixture; stirring the mixture for about 2 minutes to about 30 minutes until homogeneous; pouring the mixture into a mold; pressing upward at a pressure of about 6000 psi to form a brick; curing the brick at a temperature of about 90° C. to form the refractory brick.

In further embodiments, a refractory brick product, can include a plurality of brick substrates; and at least cured geopolymer composition, wherein the geopolymer composition can include a metakaolin; a metal silicate in a solvent; and at least one filler.

In some embodiments, a fire retardant construct composition, can include a vapor barrier overlay; and a geopolymer composition, wherein the geopolymer composition comprises a metakaolin; an alkali silicate in a solvent; and at least one filler.

In other embodiments, a method for preparing a fire retardant construct composition, can include placing vapor barrier overlay into a mold; pouring geopolymer composition into the mold; curing the composition in an oven at 80° C. for 1 hour to 5 hours; removing the composition from the oven; cooling the composition to room temperature; and unmolding the composition to form the fire retardant construct composition.

In some embodiments, a composition, can include a blowing agent; and a geopolymer composition, wherein the geopolymer composition comprises a metakaolin; an alkali silicate in a solvent; and at least one filler.

In other embodiments, a molded composite product, can include a plurality of substrates; a blowing agent; and at least cured geopolymer composition, wherein the geopolymer composition can include a metakaolin; an alkali silicate in a solvent; and at least one filler.

In some embodiments, a composition, can include a plurality of wood substrates; a fiberglass sheet or a cellulose sheet or a kraft paper; and a geopolymer composition, wherein the geopolymer composition can include a metakaolin; an alkali silicate in a solvent; and at least one filler.

In further embodiments, a method for preparing a three-layered composite product, can include placing a fiberglass sheet or a cellulose sheet or a kraft paper onto a wood substrate; applying a geopolymer composition on the top layer via curtain coater, dip coating, metering rod, or slot die coating; and curing the composition in an oven at 80-90° C. for 1 minute to 4 hours to produce the three-layered composite product;

In other embodiments, a three-layered composite product, can include a plurality of wood substrates; a fiberglass sheet or a cellulose sheet or a kraft paper; and at least cured geopolymer composition, wherein the geopolymer composition can include a metakaolin; an alkali silicate in a solvent; and at least one filler.

In some embodiments, a composition, can include an organic glue line; a high density kraft paper; and a geopolymer composition, wherein the geopolymer composition can include a metakaolin; an alkali silicate in a solvent; and at least one filler.

In further embodiments, a method for preparing a three-layered composite product, can include placing an organic glue line via hot pressing onto a substrate; and coating a high density kraft paper with a geopolymer composition via wire wound metering rod on external face to produce the three-layered composite product.

In other embodiments, a three-layered composite product, can include a plurality of substrates; an organic glue line, a high density kraft paper; and at least cured geopolymer composition, wherein the geopolymer composition can include a metakaolin; an alkali silicate in a solvent; and at least one filler.

In some embodiments, a geopolymer saturated kraft paper composition, can include an impregnated and/or saturated kraft paper; and a geopolymer composition, wherein the geopolymer composition can include a metakaolin; an alkali silicate in a solvent; and at least one filler.

In further embodiments, a method for preparing a geopolymer saturated kraft paper composition, can include placing a geopolymer composition into a large container; passing a raw kraft paper through the geopolymer composition; providing an A-pass treatment to the mixture; and curing the geopolymer-treated kraft paper in an oven at 80-90° C. for 1 minute to 5 hours to produce the geopolymer saturated kraft paper composition.

In other embodiments, a composite product, can include a plurality of substrates; an impregnated and/or saturated kraft paper; and at least cured geopolymer composition, wherein the geopolymer composition can include a metakaolin; an alkali silicate in a solvent; and at least one filler.

In some embodiments, a composition, can include a plurality of wood substrates; a first geopolymer composition; and a second geopolymer composition, wherein the first geopolymer composition or the second geopolymer composition can include a metakaolin; an alkali silicate in a solvent; and at least one filler.

In further embodiments, a method for preparing a three-layered composite product, can include applying a first geopolymer composition via roller, sprayer, or curtain coater onto a wood substrate; applying a second geopolymer composition via bird blade, or slot die coater onto the first geopolymer composition; and curing the composition in an oven at 80-90° C. for 1 minute to 5 hours to produce the three-layered composite product.

In other embodiments, a three-layered composite product, can include a plurality of wood substrates; at least cured a first geopolymer composition; and at least cured a second geopolymer composition, wherein the first geopolymer composition or the second geopolymer composition can include a metakaolin; an alkali silicate in a solvent; and at least one filler.

In some embodiments, a composition, can include a plurality of wood substrates; a geopolymer saturated with kraft paper or melamine sheet; and a geopolymer composition, wherein the geopolymer composition can include a metakaolin; an alkali silicate in a solvent; and at least one filler.

In further embodiments, a method for preparing a three-layered composite product, can include applying a geopolymer composition via curtain coater, dip coating, metering rod, or slot die coater onto a wood substrate; placing a geopolymer composition into a large container; passing a raw kraft paper or melamine sheet through the geopolymer composition; providing an A-pass treatment to the mixture to produce a geopolymer saturated with kraft paper or melamine sheet; placing the geopolymer saturated with kraft paper or melamine sheet onto geopolymer composition coated wood substrate; and pressing the mixture hot to adhere together to produce the three-layered composite product.

In other embodiments, a three-layered composite product, can include a plurality of wood substrates; a geopolymer saturated with kraft paper or melamine sheet; and at least cured geopolymer composition, wherein the geopolymer composition can include a metakaolin; an alkali silicate in a solvent; and at least one filler.

In some embodiments, a method for preparing a high pressure laminate composite product, can include placing a geopolymer composition into a large container; passing a raw kraft paper through the geopolymer composition; providing an A-pass treatment to the mixture; and curing the geopolymer-treated kraft paper in an oven at 80-90° C. for 1 minute to 5 hours; and pressing together multi-layered sheets of geopolymer saturated kraft paper at high pressure of about 500 psi to about 2000 psi to produce the high pressure laminate composite product.

In other embodiments, a high pressure laminate composite product, can include a plurality of multi-layered sheets of geopolymer saturated kraft paper pressed together at a high pressure of about 500 psi to about 2000 psi to produce the high pressure laminate composite product.

### BRIEF DESCRIPTION OF THE DRAWINGS

FIG. 1 depicts an illustrative view of a wood board of a plurality of wood substrates and a geopolymer composition.

FIG. 2 depicts an illustrative view of a refractory brick product of a plurality of brick substrates and a geopolymer composition.

FIG. 3 shows Alumina-Silica phase diagram, which can be used to determine compositions that can produce certain quality of refractories.

FIG. 4 depicts an illustrative view of a fire retardant overlay of a vapor barrier overlay and a geopolymer composition.

FIG. 5 depicts an illustrative view of a three-layered composite products of a plurality of wood substrates; a fiberglass sheet or a cellulose sheet or a kraft paper; and a geopolymer composition.

FIG. 6 depicts an illustrative view of a three-layered composite products of an organic glue line; a high density kraft paper; and a geopolymer composition.

FIG. 7 depicts an illustrative view of a geopolymer saturated kraft paper composition.

FIG. 8 depicts an illustrative view of a three-layered composite products of a plurality of wood substrates; a first geopolymer composition; and a second geopolymer composition.

FIG. 9 depicts an illustrative view of a three-layered composite products of a plurality of wood substrates; a geopolymer saturated with kraft paper or melamine sheet; and a geopolymer composition.

FIG. 10 depicts an illustrative view of a high pressure laminate composite product of multi-layered sheets of geopolymer saturated kraft paper pressed together at a high pressure.

### DETAILED DESCRIPTION OF THE INVENTION

### I. Definitions

The following terms are intended to have the meanings presented therewith below and are useful in understanding the description and intended scope of the present invention.

The articles “a” and “an” may be used herein to refer to one or to more than one (i.e., at least one) of the grammatical objects of the article. By way of example “an analogue” means one analogue or more than one analogue.

The term “about” as used herein, refers that the numerical value is approximate and small variations would not significantly affect the practice of the disclosed embodiments. Where a numerical limitation is used, unless indicated otherwise by the context, “about” means the numerical value can vary by ±10% and remain within the scope of the disclosed embodiments. Additionally, in phrase “about X to Y,” is the same as “about X to about Y,” that is the term “about” modifies both “X” and “Y.”

The term “compound” as used herein, refers to salts, complexes, isomers, stereoisomers, diastereoisomers, tautomers, and isotopes of the compound or any combination thereof.

The term “comprising” (and any form of comprising, such as “comprise”, “comprises”, and “comprised”), “having” (and any form of having, such as “have” and “has”), “including” (and any form of including, such as “includes” and “include”), or “containing” (and any form of containing, such as “contains” and “contain”), are used in their inclusive, open-ended, and non-limiting sense.

The term “effective,” as that term is used in the specification and/or claims, means adequate to accomplish a desired, expected, or intended result.

The term “coating” refers to a coating in a form that is suitable for application to a substrate as well as the material after it is applied to the substrate, while it is being applied to the substrate, and both before and after any post-application treatments (such as evaporation, cross-linking, curing, and the like). The components of the coating compositions may vary during these stages.

The coatings comprise an alkali metal geopolymer binder composition and may optionally comprise additional components, such as at least one carrier like filler, pigment, catalyst, or accelerator other than a binder. Coatings can be prepared using potassium geopolymer binder compositions of metakaolin, potassium silicate solution and fumed silica (SiO₂) filler and coating on a suitable substrate of choice.

Some non-limiting examples of types of binders include, but not limited to, polymeric binders. Polymeric binders (resins) can be thermoplastics or thermosets or modified natural alkyl resins and may be elastomers or fluoropolymers. Binders may also comprise monomers that can be polymerized before, during, or after the application of the coating to the substrate. Polymeric binders may be cross-linked or otherwise cured after the coating has been applied to the substrate. Examples of polymeric binders include polyethers such as poly(ethylene oxide)s (also known as poly(ethylene glycol)s, poly(propylene oxide)s (also known as poly(propylene glycol)s, and ethylene oxide/propylene oxide copolymers, cellulosic resins (such as ethyl cellulose, ethyl hydroxyethyl cellulose, carboxymethyl cellulose, cellulose acetate, cellulose acetate propionates, and cellulose acetate butyrates), and polyvinyl butyral, polyvinyl alcohol and its derivatives, ethylene/vinyl acetate polymers, acrylic polymers and copolymers, styrene/acrylic copolymers, styrene/maleic anhydride copolymers, isobutylene/maleic anhydride copolymers, vinyl acetate/ethylene copolymers, ethylene/acrylic acid copolymers, polyolefins, polystyrenes, olefin and styrene copolymers, urethane resins, isocyante resins. epoxy resins, acrylic latex polymers, polyester acrylate oligomers and polymers, polyester diol diacrylate polymers, UV-curable resins, and polyamide, including polyamide polymers and copolymers.

The coating industry is a material-intensive manufacturing industry. Materials which might be harmful to both humans and the environment are used in the manufacturing of most organic coatings. Harmful and hazardous materials used in the production process or in and after the preparation of the organic coating might volatilize into the atmosphere. The adverse impact on the environment resulting from the aforementioned materials has attracted global attention. In addition, the manufacture of organic coatings also consumes large quantities of natural resources, especially petroleum resources. The study of inorganic coatings has therefore been focused on. Inorganic coatings have many advantages. They are environmentally friendly, functional and have both technical and economic advantages. For example, sodium, potassium as well as lithium silicate resin cements, silica sols, phosphates and polysiloxanes are inorganic coating components.

The concept of geopolymers was brought up by Joseph Davidovits in the 1970s. The gist of this concept is an aluminum silicate inorganic polymer formed by geochemistry. The geopolymer has a network-like structure of amorphous inorganic polymer which has excellent adhesive properties, and especially shows a high bond strength in an early stage. Geopolymers also have the properties of good acid resistance, alkali resistance, seawater and high temperature resistance. Due to their impermeability, high degree of compactness, antifreeze properties, and especially excellent interface coalescence, geopolymers can be combined with different base materials to form a solid surface which can maintain long-term volume stability.

A wide range of products can be created by using geopolymers. Coatings are one of them. Coatings are decorative, protective and functional products. The majority thereof should have a desirable color. Therefore, white metakaolin as an aluminum silicate polymer can be provided for a white coating matrix, which also helps preparing bright colors. The color of the coating prepared from the geopolymer binder compositions according to the invention can be adjusted by incorporating one or more colorants such as organic or inorganic pigments or dyes into the geopolymer binder compositions. The type and amounts of the colorants can be chosen by a skilled person according to the requirements and are not restricted as long as the advantages of the invention are not impaired. As will be explained below, the coatings of the present invention can be used for various purposes. In order to modify the properties of the coating according to the needs, the geopolymer binder compositions can contain one or more optional components. The type and amount of the optional components will depend on the ultimate use of the geopolymer composition and are not particularly restricted. Examples of typical optional components are toughening agents, dispersing agents, plasticizers, levelling agents, and thickening agents. Furthermore, one or more functional agents which modify the properties of the geopolymer coating according to the intended use can be additionally contained in the geopolymer binder compositions.

Examples of such functional agents include, but not limited to, fire flame retardant agents (e.g., expanded graphite, melamine, hydrated glass powder, pentaerythritol, aluminum hydroxide); antimony trioxide, spherical closed cell expanded perlite, expanded vermiculite, fly ash particles, hollow glass beads, ceramic fiber powder, rockwool fiber powder); anti-rust agents (e.g., micaceous iron oxide, zinc metal, zinc powder, zinc oxide, glass flakes); antimicrobial agents (e.g., Ag₃PO₄—Zn₃(PO_{-I})₂, (Ag—Zn) antimicrobial powder); stealth agent (e.g., high temperature ceramic metal oxide powder (cobalt, manganese, nickel, iron, barium, and zinc), iron carbonyl); conductive agents (e.g., iron carbonyl powder, silver-copper, silver-nickel, silver glass powder, silver mica powder); heat agent (e.g., aluminum powder, stainless steel powder); lubricants (e.g., graphite phosphate tablets, (MoS₂)); metal protective agent (e.g., alkali glass powder, silicon carbide powder); antifouling agents (e.g., cuprous oxide, capsaicin); temperature indication agent (e.g., Cu₂(HgI₄), C0C₁₂ six-tetramine); and anti-radiation agent (e.g., PbO, BaSO₄, Fe₂O₃). Both the types and the amounts of the functional agent can be selected by a skilled person based on his general knowledge of the field.

The composition according to the present invention can be used to prepare a wide variety of coatings. Examples of possible coatings include, but not limited to, anti-crack architectural coatings, waterproof architectural coatings, zinc-rich coatings, anti-crack insulation coatings, waterproof insulation coatings, fire resistant coatings, anti-rust coatings, anti-mildew coatings, stealth coatings which are invisible to radar waves, conductive coatings, heat-proof coatings, lubricating coatings, antioxidant and anti-oxidation coatings, anti-pollution coatings, temperature indication coatings, anti-radiation coatings, and waterproof coatings. The coatings can be suitable for indoor and/or outdoor applications. If desired the coatings can be flexible.

In some embodiments, the deposition of an alkali metal geopolymer binder compositions onto the substrate is carried out by drop-cast, spray-cast, spin coating, dip coating, flow coating, knife coating, curtain coating, slot coating, brushing, dipping, spreading, spraying, wiping, or combinations thereof.

The geopolymer compositions of the present invention are advantageous because they do not rely on petrochemical products. Therefore, they do not require any volatile organic solvents or emit any volatile organic compounds. Rather, they can be formulated only using water as a solvent. In addition, they do not have aging problems, are incombustible, anti-corrosive, possess high strength, and are environmental friendly. Furthermore, the geopolymer-containing filler particles have a good flowability.

A composite material is a material of two or more components with different properties, which together give the final product properties that none of its components have in themselves. Composite materials, or composite products for short, consist of a matrix, also called a binder, and a reinforcement, called a filler. Reinforcement is a discontinuous component of the composite that is harder, stiffer and significantly stronger than the matrix. The matrix is a continuous component of the composite that connects the reinforcement. The matrix protects the reinforcement from external influences and prevents its damage.

Geopolymer materials or geopolymers are among the ceramic materials. It belongs to the aluminosilicates. Their advantage over traditional ceramic materials is their preparation at room temperature and very low shrinkage during maturation. Geopolymers excel in their resistance to temperatures higher than 1100° C. and chemical resistance. Geopolymers usually consist of a geopolymeric binder forming a matrix and a filler that has a reinforcing function. Geopolymeric binders are covalently bonded mineral polymers. Fillers in conjunction with a geopolymic binder generally give the resulting composite stiffness and strength, particularly if the chosen filler is reactive in nature and can participate in the geopolymerization reaction. However, a wide range of other materials can be incorporated into the structure of geopolymers, which then play a very significant role not only in their resulting mechanical properties, but also in their thermodynamic properties.

### II. Wood Composite Product

The invention provides a composition for a new geopolymer based binder for use as an adhesive in the production of particle board (sandwich board or PB), plywood (PLY) and oriented strand board (OSB). In addition, the new geopolymer adhesive will improve the fire retardant properties of the wood panel construct and a process for manufacturing the same. Conventional liquid formaldehyde based resins have limited latitude to bond veneer at higher moisture content because of solubility and viscosity requirements that restrict the range of possible high molecular weight components. The present invention is an improvement in adhesive technology and bonding process to accommodate variations in wood substrate moisture content (% MC) and structure are recognized as important objectives for future wood panel/product development. The new geopolymer adhesive could potentially be used to glue relatively high moisture content wood species (including green wood) at lower/moderate temperature versus the incumbent (formaldehyde based resin technologies). In addition to the process advantage, it can also result in a fire resistant panel. Substitution of wood components such as lignin and tannins for phenolic resin wood adhesives has been of great interest in recent years. This approach of using a component of wood as an adhesive has yielded a mixed bag of results and mostly sacrificing adhesive properties from the economical aspect. The geopolymer adhesive/binder presents the panel manufacturers with an alternative that not only retains physical performance but also imparts fire retarding properties.

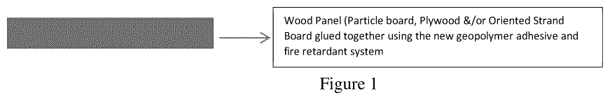

FIG. 1 depicts an illustrative view of a wood board of a plurality of wood substrates and a geopolymer composition. The geopolymer composition can include a metakaolin; an alkali silicate in a solvent; and at least one filler.

In some embodiments, a geopolymer composition, can include a metakaolin; an alkali silicate in a solvent; and at least one filler.

In other embodiments, the alkali silicate is selected from the group consisting of potassium silicate, sodium silicate, and mixtures thereof.

In further embodiments, the solvent can include an alkanol, an aromatic alcohol, and water.

In one embodiment, the solvent is water.

In certain embodiments, the filler is selected from the group consisting of multi-purpose sand, titanium dioxide, calcium carbonate, silicon dioxide, lignosulfonate, powdered graphite, cristoballite, feldspar, wollostonite, perlite, other aluminosilicate derivates, melamine, bisphenol A, sodium sulfate, sodium bicarbonate, hexamine, soda ash, sodium meta bisulfite, ammonium sulfate, elvamide, ethylene glycol, guar gum, stannous chloride, glycerin, paraformaldehyde, wheat/gluten flour, lithium carbonate, ammonium acetate, molasses, polyvinyl butural, polyvinyl alcohol, polyvinyl acetate, caprolactam, carboxy methyl cellulose (CMC), and mixtures thereof.

In some embodiments, the metakaolin is present in an amount from about 5 wt % to about 50 wt % based on the total composition.

In other embodiments, the alkali silicate is present in an amount from about 5 wt % to about 70 wt % based on the total composition.

In certain embodiments, the filler is present in an amount from about 0 wt % to about 90 wt % based on the total composition.

In another embodiment, two or more fillers are present.

In other embodiments, the filler has an average particle size from about 0.001 micron to about 5 mm.

In further embodiments, the composition is cured at a temperature of about 60° C. to about 100° C.

In one embodiment, the composition is cured at a temperature of about 80° C.

In some embodiments, the composition cure time ranges from about 5 min to about 10 hours.

In other embodiments, the composition has a viscosity of about 5 cP to about 100,000 cP at a temperature of about 25° C.

In further embodiments, the average flexural strength of the composition ranges from about 0.5 MPa to about 50 MPa.

In certain embodiments, a coating is prepared from the geopolymer composition.

In one embodiment, the total thickness of the coating is from about 0.5 gsm to about 100 gsm.

In another embodiment, the coating is applied with groove rod, paint roller or combinations thereof.

In further embodiments, the geopolymer composition can include an alkali metal geopolymer composition.

In some embodiments, the alkali metal geopolymer composition is potassium metal geopolymer composition, sodium metal geopolymer composition or combinations thereof.

In certain embodiments, the alkali metal is selected from the group consisting of lithium, sodium, potassium, rubidium, cesium, and mixtures thereof.

In further embodiments, a method for preparing a wood composite product, can include contacting a plurality of wood substrates with a geopolymer composition, wherein the geopolymer composition can include a metakaolin; an alkali silicate in a solvent; and at least one filler; and curing the composition at a temperature of about 25° C. to about 250° C. and at a pressure of about 100 psi to about 5000 psi to produce a wood composite product.

In other embodiments, a wood composite product, can include a plurality of wood substrates; and at least cured geopolymer composition, wherein the geopolymer composition can include a metakaolin; an alkali silicate in a solvent; and at least one filler.

In one embodiment, the plurality of wood substrates can include lignocellulose substrates.

In certain embodiments, the wood composite product can include plywood, oriented strand board, oriented strand lumber, laminated veneer lumber, laminated veneer timber, laminated veneer boards, particleboard, fiberboard, chipboard, flakeboard, high density fiberboard, medium density fiberboard, waferboard, hardwood, softwood plywood, veneer timber, parallel standard lumber, oriented stranded lumber, or combinations thereof.

In some embodiments, a method for preparing a particle board, can include loading a wood furnish into a blender; applying a geopolymer composition to the wood furnish via atomized spray; placing the wood furnish in a 12″×12″ mold via felting process to form a molded panel; unmolding the molded panel via pre-pressing with body weight pressure to form a pre-press panel; placing a wax paper over the pre-pressed panel in order to prevent sticking to the heated press; curing the panel at a temperature of about 180° F. to about 300° F. for about 5 minutes to about 1 hour and at a pressure of about 1 psi to about 500 psi; pressing the warm panel together under 18-lb weights via hot stacking process; and heating the panel at a temperature of about 180° F. in an oven for about 1 hour to about 4 hours to produce the particle board.

In other embodiments, a method for preparing a plywood, can include applying a geopolymer composition to a plywood veneer on both faces via roller, wire round metering rod, slot die coater, doctor blade, or paint brush; placing the veneer faces together in perpendicular fashion with respect to wood grain; pressing the veneer faces at a temperature of about 180° F. to about 250° F. for about 5 minutes to about 30 minutes at a pressure of about 1,500 psi to form a plywood construct; removing the plywood construct from pressed condition; and placing the plywood construct under 80 lb weight for 48 hours at room temperature to form the plywood.

### Forming the Plywood Sheets

The process of laying up and gluing the veneer pieces together started when the appropriate sections of veneer were assembled for a particular run of plywood. This can be done manually or semi-automatically with machines. In the simplest case of three-ply sheets, the back veneer was laid flat and run through a glue spreader, which applied a layer of glue to the upper surface. The short sections of core veneer were then laid crossways on top of the glued back, and the whole sheet was run through the glue spreader a second time. Finally, the face veneer was laid on top of the glued core, and the sheet was stacked with other sheets waiting to go into the press. The glued sheets were loaded into a multiple-opening hot press. Presses can handle 20-40 sheets at a time, with each sheet loaded in a separate slot. When all the sheets were loaded, the press squeezed them together under a pressure of about 110-200 psi (7.6-13.8 bar), while at the same time heated them to at a temperature of about 230° F. to about 315° F. (109.9-157.2° C.). The pressure assured good contact between the layers of veneer, and the heat caused the glue to cure properly for maximum strength. After a period of about 2-7 minutes, the press was opened and the sheets were unloaded. The rough sheets then passed through a set of saws, which trimmed them to their final width and length. Higher grade sheets passed through a set of 4 ft (1.2 m) wide belt sanders, which sand both the face and back. Intermediate grade sheets were manually spot sanded to clean up rough areas. Some sheets were run through a set of circular saw blades, which cut shallow grooves in the face that gave the plywood a textured appearance. After a final inspection, any remaining defects were repaired. The finished sheets were stamped with a grade-trademark that gives the buyer information about the exposure rating, grade, mill number, and other factors. Sheets of the same grade-trademark were strapped together in stacks and moved to the warehouse to await shipment.

### II. Refractory Bricks

The invention provides a composition for a new geopolymer based binder for use as a binder in the production of fire retardant, chemically resistant, thermo-mechanically stable refractory brick and a process for manufacturing the same.

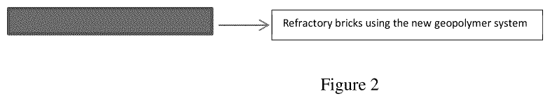

FIG. 2 depicts an illustrative view of a refractory brick product of a plurality of brick substrates and a geopolymer composition. The geopolymer composition can include a metakaolin; an alkali silicate in a solvent; and at least one filler.

Basic industry processing materials from the bowels of the earth require high-temperature processing and the use of refractories. Refractories need to insulate and control the process temperature and to minimize heat loss from the process. They are required to insulate the vessel or support structure from the process temperature to prevent overheating and deterioration of the support structure. Without the support or structure, the high-temperature process cannot be contained. Refractories deteriorate from either or both chemical and mechanical effects. Refractory materials, by definition, are supposed to be resistant to heat and are exposed to different degrees of mechanical stress and strain, thermal stress and strain, corrosion/erosion from solids, liquids and gases, gas diffusion, and mechanical abrasion at various temperatures. Different refractories are designed and manufactured so that the properties of the refractories will be appropriate for their applications. In most cases, refractory properties can be predicted from the results of appropriate tests; for others, knowledge and experience predict the refractory properties where direct tests correlating the properties are not available. The testing of refractory properties can, in most cases, indicate the performance of a refractory in actual application. Refractories are mostly used (70%) in basic metal industries. It is obvious that the property requirements of refractories vary significantly according to the application and use in different processes. Hence, individual refractories need to be designed with characteristic properties for specific systems since the requirements vary with different high-temperature processes. Refractories are broadly divided into two categories—shaped (bricks and cast shapes) and unshaped (monolithic) refractories. There are two kinds of shaped refractories—the primary kind is like brick or similar shapes and the other kind is the shapes made from monolithic refractories, where they are dictated by the properties of the monolithic refractories. For shaped refractories (like brick making), attaining maximum density after the shapes are formed is the goal of the process. Refractory materials are characterized by their physical properties, which often indicate the use and performance of refractory materials. The predictability of refractory uses in specific applications is, in most cases, dictated by past experience. In general, the basic physical properties can often indicate whether a refractory material can be used for intended applications. The following basic physical properties are often used to predict, select, and prescribe refractories for specific applications: Density, porosity, cold, hot and abrasion are important properties to track. The industry uses ASTM D-20 to measure density and porosity. In general, the higher the density, the lower the porosity tends to be. Also, other physical properties, such as strength, abrasion, and gas permeability, are often related to the density and porosity of the refractory. In addition, the physical strengths, in both cold and hot conditions, are often characterized as measures of the use of a refractory. Cold strengths indicate the handling and installation of the refractory, whereas hot strengths indicate how the refractory will perform when used at elevated temperatures. Cold Compressive Strength The industry uses ASTM C-133 to measure cold compressive strength, ASTM C-133 to measure cold modulus of rupture and ASTM C-583 for hot modulus of rupture.

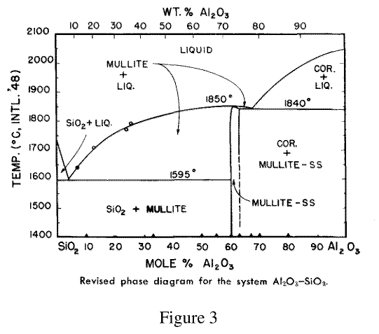

Arclin's proprietary Alumino-Silicate based geopolymers are different from the current Alumina-Silica refractories. FIG. 3 shows Alumina-Silica phase diagram, which can be used to determine compositions that can produce certain quality of refractories (Aramaki, S.; Roy, R. J. Am. Ceram. Soc. 1962, 45, 229-242). The phase diagram was obtained by heating various mixtures of alumina and silica to various temperatures and a compound known as mullite is formed. Above 72% (<100%) Al₂O₃ content, the solidus line is located at 1840° C. and will remain a solid for the purposes of refractoriness. Also, pure Al₂O₃ has a melting point of ˜2050° C. The current Alumina-Silica refractory bricks can be classified in terms of their “refractory readiness/Refractoriness/capabilities” based on the phase diagram in FIG. 3. Traditionally, Alumina-Silica bricks are manufactured from a blend of sized raw material aggregates and clays. The blend is mixed, formed, dried to get the final brick by firing. The modern dry pressed (less water) super-duty fireclay and high-alumina brick tend to have finer pore sizes and structures in comparison to the more “older” extruded bricks. It is important to note that traditional Fireclay bricks are susceptible to alkali attack. The bricks tend to expand in alkali-rich environment resulting in cracking and disintegration within the refractory. It is important to note that fireclay bricks disintegrate in the presence of carbon monoxide due to their iron oxide content. Essentially, lower porosity equals improved fracture toughness and improved thermal shock behavior. In the refractory world, alumina-silica is used to make, 1. Fireclay refractory bricks, 2. Semicordierite brick (low thermal expansion) and Kiln Furniture and 3. Insulating firebricks. One of the “weaknesses” of alumina-silica brick is their potential for reaction with basic slag or other corrosives to form melted phases/liquid in relatively low temperatures. In contrast, Arclin's geopolymers are inorganic (covalently bonded) mineral polymers with low porosity, defined microstructure, and can be easily tailored to suit a variety of refractory needs. Some properties that can be tuned with such materials are density, compressive strength, flexural strength, coefficient of thermal expansion, shrinkage tendency, and hardness. These mineral materials, being covalently bonded macromolecules with a well-defined 3-dimensional structure, maintain structural and chemical stability at advanced temperatures (>1000° C.), retain their amorphous nature, and do not sinter. In addition to possessing inherent thermal and chemical stability (particularly in regards to acid resistance), Arclin geopolymers and geopolymer composite materials can be fabricated without the practice of firing, hardening at temperatures less than 100° C. Arclin geopolymers can also be formulated to harden within hours at room temperature, cutting their energy footprint and overall cost.

In some embodiments, a refractory brick composition, can include a plurality of brick substrates; and a geopolymer composition, wherein the geopolymer composition can include a metakaolin; a metal silicate in a solvent; and at least one filler.

In other embodiments, the geopolymer composition can include a metal geopolymer composition.

In certain embodiments, the metal is selected from the group consisting of lithium, sodium, potassium, rubidium, cesium, calcium, magnesium, and mixtures thereof.

In further embodiments, the metal geopolymer composition is potassium metal geopolymer composition, sodium metal geopolymer composition, calcium metal geopolymer composition, magnesium metal geopolymer composition or combinations thereof.

In certain embodiments, the filler is selected from the group consisting of multi-purpose sand, titanium dioxide, calcium carbonate, silicon dioxide, lignosulfonate, powdered graphite, cristoballite, feldspar, wollostonite, perlite, other aluminosilicate derivates, melamine, bisphenol A, sodium sulfate, sodium bicarbonate, hexamine, soda ash, sodium meta bisulfite, ammonium sulfate, elvamide, ethylene glycol, guar gum, stannous chloride, glycerin, paraformaldehyde, wheat/gluten flour, lithium carbonate, ammonium acetate, molasses, polyvinyl butural, polyvinyl alcohol, polyvinyl acetate, caprolactam, carboxy methyl cellulose (CMC), and mixtures thereof.

In one embodiment, two or more fillers are present.

In some embodiments, the refractory brick composition can further include an additive.

In other embodiments, the additive can include an aldehyde-based resin.

In further embodiments, the aldehyde-based resin is selected from the group consisting of a phenol-formaldehyde resin, a urea-formaldehyde resin, a melamine-formaldehyde resin, a melamine-urea-formaldehyde resin, a phenol-melamine-formaldehyde resin, a resorcinol-formaldehyde resin, or a phenol-resorcinol-formaldehyde resin, and combinations thereof.

In other embodiments, a method for preparing a refractory brick, can include loading a plurality of brick substrates; applying a geopolymer composition to the brick substrates to form a mixture; stirring the mixture for about 2 minutes to about 30 minutes until homogeneous; pouring the mixture into a mold; pressing upward at a pressure of about 6000 psi to form a brick; curing the brick at a temperature of about 90° C. to form the refractory brick.

In further embodiments, a refractory brick product, can include a plurality of brick substrates; and at least cured geopolymer composition, wherein the geopolymer composition can include a metakaolin; a metal silicate in a solvent; and at least one filler.

### IV. Fire Retardant Construct

This invention provides a geopolymer based composite alternative with improved fire retardancy, moisture barrier, chemical resistance and mechanical properties versus the traditional gypsum and MgO boards. The invention utilizes Arclin's commercial vapor barrier overlay (VBO) technology or fire retardant overlay (FRO) plus a unique geopolymer formulation with appropriate fillers such as, lignosulfonates etc. This composite is made in a mold where the VBO or the FRO can form the base layer and the geopolymer binder and the filler of choice are poured on top and allowed to set at 80° C. for 1 hour to 5 hours.

Many modern building codes require the use of barriers in construction to protect the building from air and water penetration. For example, building codes in eastern Canada and the northeastern United States require air barriers to be used in all construction. Moreover, the existing International Building Code/International Residential Code (IBC/IRC) requires the use of a water-resistive air barrier for all new construction. Water-resistive air barriers may be formed from a variety of materials and structures and applied to the surface of construction sheathing materials (e.g., gypsum panels, oriented strand board (OSB) panels and magnesium oxide boards).

Traditionally, three types of water-resistive air barriers may be used to meet building codes. First, fabric-type membranes, or “wraps,” may be used to cover the surface of building sheathing panels. Second, a liquid coating water-resistive air-barrier membrane may be applied to sheathing panels. Third, self-adhered, or “peel and stick,” water-resistive air-barrier membranes may be applied to sheathing panels. Accordingly, it would be desirable to provide improved external sheathing panels and building sheathing systems having water-resistive and air-barrier properties as well as methods of making such panels.

There are several patents (CA2975742C, U.S. Pat. No. 9,869,089B2, EP3909938A1, EP3909938A4) that describe gypsum panels and building sheathing systems that have water-resistive and air barrier properties as well as methods of making and using such panels and systems. These panels and systems provide advantages over commercially available water-resistive air barriers that are attached to traditional gypsum sheathing (e.g., mechanically attached flexible sheet, self-adhered sheets, fluid-applied membranes, spray foams), as well as over wood-based (e.g., oriented strand board) panels, which do not display the needed fire-resistance properties. However, these gypsum boards are not mold resistant and tend to be friable. A similar conclusion can be made on the more recent patents using magnesium oxide panels. Magnesium oxide panels are at best a “me too” to the incumbent gypsum.

Traditional gypsum sheathing panels do not consistently pass industry standard bulk water holdout tests and therefore are typically covered with commercially available water-resistive air barriers (e.g., mechanically attached flexible sheets, self-adhered sheets, fluid-applied membranes or coatings, sprayed foams).

A widely accepted test method for flame retardant treated wood is the ASTM E-84 developed by the American Society for Testing and Materials (ASTM). Building materials meeting the Class A ASTM E-84 standard have a flame spread index greater than zero (0) but less than 25. It is well known that inorganic materials such as Portland cement, magnesium cement and magnesium oxide boards are fire retardant but could explode above a certain temperature. Existing practices in Class A ASTM E-84 fire retardant treated wood products such as plywood or lumber are to infuse the wood fiber material with an aqueous solution of a water soluble flame retardant formulation such as phosphates and/or borates. This infusion is typically performed under vacuum pressure, which requires a subsequent drying step after the infusion process. The subsequent drying step involves removing water from the product, such as by kiln drying, to return the product to its original moisture content. The infusion process has several drawbacks. First, wood based products tend to check and warp due to changes in moisture content during the treating and drying processes. In some cases, warped materials may cause problems to the end user. Second, because most flame retardants are acidic, the infusion and subsequent drying process tends to reduce the strength of wood based products. This occurs when the water absorbed by the treated wood reacts chemically with the fire retardant to produce a condition known as hydrolysis. Hydrolysis, which is especially damaging under high temperature and high humidity conditions, attacks the fiber of the wood causing it to become brittle and lose strength. Some flame retardants decompose at high temperatures, a process which increases their acidity and leads to accelerated wood polymer hydrolysis. Third, the effectiveness of the infusion process may be reduced if the treated wood is subsequently exposed to water.

A “me too” technology to gypsum is Magnesium based cementitious materials. Magnesia (magnesium oxide) is known for its excellent fire resistance and is used in refractory materials. The same applies for magnesium oxychloride cement (MOC), also known as Sorel cement, which was invented in the 19th century. Other types of well-known cementitious materials include magnesium oxysulfate cement (MOS) and magnesium phosphate cement (MAP). When made into sheets or boards as construction materials, these cementitious materials are known on the market place as MgO board or simply MgO. MgO boards are widely available around the world. Some MgO board manufacturers claim to use proprietary formulations and processes for special performance. These MgO boards, the cementitious layers are formed on the foundation material by applying a polyvinyl alcohol (PVA) primer and then spraying or manually spreading the cementitious layer on the foundation material. The cementitious laminate composition described by the patents have sufficient strength to resist chipping and cracking, but are not claimed to be fire resistant. In any case, the polyvinyl alcohol primer likely has a melting point of around 200° C. or lower and would fail in the case of a fire. Usually, the components for preparing the magnesium oxide fireproof board include active high-purity magnesium oxide (MgO), high-quality magnesium chloride (MgCl₂), alkali-resistant glassfiber fabrics, plant fiber, incombustible lightweight perlite, chemically stable lithopone, high-molecular polymers and high-performance modifiers. A Chinese Patent No. CN101871246B discloses an MGO board, which is prepared from a forming agent, a reinforcing material, a lightweight filler, a modifier and water, wherein the forming agent is magnesium oxide, magnesium sulfate and magnesium chloride, the reinforcing material is glassfiber mesh fabric or other reinforcing materials, and the modifier includes a whitening agent, a stabilizer and a toner. In the above existing technical solution, glassfiber mesh fabric is used as the reinforcing material, and due to the excellent toughness of glassfiber mesh fabric, the internal bonding strength is low when glassfiber mesh fabric is combined with other materials; and when the MGO board is slotted from the outside during mounting, peeling may easily occur at the slotted position of the MGO board subjected to a shearing force and cause cracking at the opening of the slot, thus influencing the practicability of the MGO board.

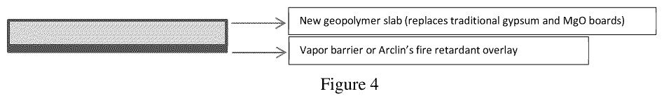

FIG. 4 depicts an illustrative view of a fire retardant overlay of a vapor barrier overlay and a geopolymer composition. The geopolymer composition can include a metakaolin; an alkali silicate in a solvent; and at least one filler. The construct does not limit the position of any particular layer for a vapor barrier overlay and a geopolymer composition. The vapor barrier overlay and geopolymer composition can be either in top, or bottom layers.

In some embodiments, a fire retardant construct composition, can include a vapor barrier overlay; and a geopolymer composition, wherein the geopolymer composition comprises a metakaolin; an alkali silicate in a solvent; and at least one filler.

In another embodiment, the geopolymer composition is an alkali metal geopolymer composition.

In certain embodiment, the geopolymer composition is potassium metal geopolymer composition, sodium metal geopolymer composition or combinations thereof.

In other embodiments, a method for preparing a fire retardant construct composition, can include placing vapor barrier overlay into a mold; pouring geopolymer composition into the mold; curing the composition in an oven at 80° C. for 1 hour to 5 hours; removing the composition from the oven; cooling the composition to room temperature; and unmolding the composition to form the fire retardant construct composition.

### V. Geopolymer-based Molded Products

This invention provides a composition for a new geopolymer based binder for use as an mix for molding (similar to refractory bricks but with tunable flexibility, porosity and other mechanical properties based on molds and the end application), extrusion, insulating low-density foams produced in tandem with a blowing agent (H₂O₂, sodium perborate) that can be utilized at high temperature, fiberglass mat for interiors (both homes/commercial—Any fiberglass mat, woven and/or non-woven, made with formaldehyde based resin or non-formaldehyde resin or any other adhesive system including, but not limited to, “caked up” gypsum like minerals sealing the fiberglass mat surface (reducing porosity) can be further coated with Arclin's geopolymer to enhance fire retardancy that also retains the original fiberglass mat's flexibility) & wall boards type applications that require both fire retardant behavior and no added formaldehyde systems/low volatile content systems and a process for manufacturing the same. In regards to insulation systems, geopolymer foams offer remarkable temperature performance, withstanding temperatures of approximately 1000° C. Additionally, there is no release of toxic chemicals when exposed to fire. The ability of geopolymer materials to readily absorb and desorb water vapor while maintaining mechanical integrity additionally makes them attractive materials for passive cooling systems, similar to adobe.

With the mass production of dry cement in the early 1900s, stucco siding entered a new era. Cement increased the workability of stucco, with longer drying times allowing builders greater freedom. Yet the southwest remained the perfect place for stucco, due to arid conditions and high sand content that made the soil stable.

Attempts at installing traditional stucco in climates farther north and east met with mixed results. In regions where the soil moved, causing house foundations to settle, cracks appeared in the stucco that allowed rain to penetrate and loosen the siding from its sheathing. Today, the addition of polymers and other agents for increased flexibility, along with refined application techniques, have improved stucco's resilience, making it a growing choice throughout the United States.

Stucco is appealing for a number of reasons, chief among them its fire resistance. A 1-inch coating of stucco provides a one-hour firewall rating, which means it will prevent the spread of fire from one side of the wall to the other side for at least one hour. This makes stucco desirable for multi-family dwellings with strict fire codes, and those in neighborhoods where houses are built in close proximity to each other. The appearance and appealing hues from soft shades to deep earthy tones have been achieved by adding dyes to the mix. Customarily, stucco was often paired with flat roofs and clay tile roofing material, the surface appears attractive, and stucco on homes with pitched roofs and paired with both shingle and metal roofing materials.

Due to its brittle nature, stucco siding will crack if a house foundation settles. It simply is not the best choice in regions where soil is high in clay, notorious for swelling and causing foundations to shift. Over time, even stucco on homes with firm foundations can develop hairline cracks. While small cracks will not affect the integrity of the siding and can often be repaired without calling a pro, cracks of ¼-inch or wider spell trouble. Some stucco homes built after WWII were created with a spray-on form that did not prove as sturdy as traditional hand-troweled stucco. As time goes on, these homes may be prone to large multiple cracks and/or chunks of stucco falling off, and the only real option is to have the faulty siding removed and replaced. Finally, stucco has not got an appreciable insulation factor: A 1-inch layer of stucco has a 0.20 R-value, which means it only has 20 percent of the insulation factor found in the same thickness of wood, none too desirable in a cold New England winter.

Stucco Application Process:

Stucco is installed in layers, a time-consuming, labor-intensive process done by skilled pros—not a job for even the most ambitious DIYer and thus, it can be pricey. The application process depends on the house's structure—wood-framed walls require more coats of traditional stucco than block or concrete. By applying stucco in layers and allowing each layer to set, the contractor gradually builds up the thickness of the siding. Traditional stucco is applied in a three-coat process to wood-frame exterior walls. It starts with a “scratch coat” spread over metal lath attached to a house's exterior sheathing. The rough surface allows the next layer, the “brown coat,” to adhere. The brown coat adds strength and acts as a base for the “finish coat,” which can be hand-troweled to create a custom surface texture. Two-coat stucco is used on concrete, brick, and block walls. The existing masonry makes a scratch coat unnecessary. Instead of metal lath, a bonding adhesive can be applied to the masonry wall before two coats of stucco are applied.

One-coat stucco is a relatively new process using stucco mixed with fiberglass, applied over metal lath. Stucco constructions need more care and maintenance. Steps must be taken to reduce soil movement. By installing good guttering and downspouts, and by grading your yard to slope away from the foundation, soil saturation can be limited and lessen the risk of foundation movement. Dirt and debris that gets collected on stucco with a medium-bristle brush and a garden hose can be removed. Cleaning with a high-pressure washer is not recommended, as it can damage the surface. To remove mold, combine one-part non-chlorine bleach with three parts water and apply directly to the stains with a sponge or brush. Allow the solution to soak into the surface before rinsing with a hose. Efflorescence, a white stain that can develop on stucco exposed to prolonged moisture, can be removed by spraying with white vinegar. Allow several minutes of dwell time before rinsing with a hose. Re-treat if necessary to completely remove the stain.

In some embodiments, a composition, can include a blowing agent; and a geopolymer composition, wherein the geopolymer composition comprises a metakaolin; an alkali silicate in a solvent; and at least one filler.

In other embodiments, the blowing agent is selected from the group consisting of hydrogen peroxide, sodium perborate, azodicarbonamide, azo-bis-isobutyronitrile, diphenylene oxide disulphohydrazine, pyrocarbonic esters, acetonitrile, butyronitrile, isobutyronitrile, acetaldoxime, butyraldoxime or isobutyaldoxime, and mixtures thereof.

In another embodiment, the geopolymer composition is an alkali metal geopolymer composition.

In certain embodiment, the geopolymer composition is potassium metal geopolymer composition, sodium metal geopolymer composition or combinations thereof.

In other embodiments, a molded composite product, can include a plurality of substrates; a blowing agent; and at least cured geopolymer composition, wherein the geopolymer composition can include a metakaolin; an alkali silicate in a solvent; and at least one filler.

### VI. Three-Layered Composite Products (Geopolymers, Fiberglass/Cellulose/Kraft Paper, Wood Substrates)

The invention provides a new geopolymer-based composite in which a wood substrate (plywood, particle board, medium density fiberboard, oriented strand board, etc) is coated with a geopolymer coating or paint with an intermediate fiberglass, cellulose sheet, or paper layer for use in internal or external building applications as a fire retardant and chemically resistant alternative. The intermediate layer can act as an aid for adhesion between the wood substrate and geopolymer coating, providing more surface area for a greater mechanical bond.

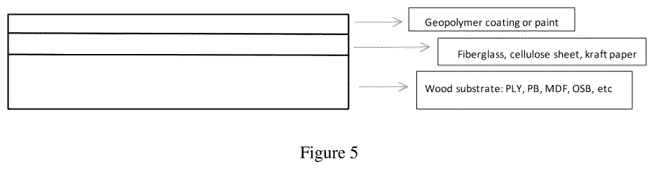

FIG. 5 depicts an illustrative view of a three-layered composite products of a plurality of wood substrates; a fiberglass sheet or a cellulose sheet or a kraft paper; and a geopolymer composition. The geopolymer composition can include a metakaolin; an alkali silicate in a solvent; and at least one filler. The construct does not limit the position of any particular layer for a wood substrate; a fiberglass sheet or a cellulose sheet or a kraft paper; and a geopolymer composition. The geopolymer composition; fiberglass sheet or cellulose sheet or kraft paper; and wood substrate can be either in top, middle or bottom layers.

In some embodiments, a composition, can include a plurality of wood substrates; a fiberglass sheet or a cellulose sheet or a kraft paper; and a geopolymer composition, wherein the geopolymer composition can include a metakaolin; an alkali silicate in a solvent; and at least one filler.

In further embodiments, a method for preparing a three-layered composite product, can include placing a fiberglass sheet or a cellulose sheet or a kraft paper onto a wood substrate; applying a geopolymer composition on the top layer via curtain coater, dip coating, metering rod, or slot die coating; and curing the composition in an oven at 80-90° C. for 1 minute to 4 hours to produce the three-layered composite product;

In other embodiments, a three-layered composite product, can include a plurality of wood substrates; a fiberglass sheet or a cellulose sheet or a kraft paper; and at least cured geopolymer composition, wherein the geopolymer composition can include a metakaolin; an alkali silicate in a solvent; and at least one filler.

### VII. Three-Layered Composite Products (Geopolymers, High Density Kraft Paper, Organic Glue Line)

This invention provides a new geopolymer-based composite for use in the internal overlay for countertops, cabinetry, flooring, and shelving. The embodiment also includes the composite of a high-density (high grammage) kraft paper with a geopolymer coating or paint on an externally face and an organic coating on the internal face to act as a glue line for a more traditional adhesive for use as an overlay. The resultant coated paper will be fire resistant, chemically resistant, and water resistant and has use as an internal and/or external overlay

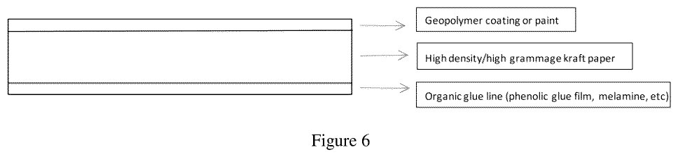

FIG. 6 depicts an illustrative view of a three-layered composite products of an organic glue line; a high density kraft paper; and a geopolymer composition. The geopolymer composition can include a metakaolin; an alkali silicate in a solvent; and at least one filler. The construct does not limit the position of any particular layer for an organic glue line; a high density kraft paper; and a geopolymer composition. The geopolymer composition; high density kraft paper; and organic glue line can be either in top, middle or bottom layers.

In some embodiments, a composition, can include an organic glue line; a high density kraft paper; and a geopolymer composition, wherein the geopolymer composition can include a metakaolin; an alkali silicate in a solvent; and at least one filler.

In another embodiment, the organic glue line is selected from the group consisting of melamine, phenolic, polyurethane, epoxy, polyvinyl acetate, polyvinyl butyral or maleic anhydride polyolefins and mixtures thereof.

In further embodiments, a method for preparing a three-layered composite product, can include placing an organic glue line via hot pressing onto a substrate; and coating a high density kraft paper with a geopolymer composition via wire wound metering rod on external face to produce the three-layered composite product.

In other embodiments, a three-layered composite product, can include a plurality of substrates; an organic glue line, a high density kraft paper; and at least cured geopolymer composition, wherein the geopolymer composition can include a metakaolin; an alkali silicate in a solvent; and at least one filler.

### VIII. Geopolymers Saturated Kraft Paper

The invention provides a new geopolymer for use in the impregnation and saturation of raw kraft paper. The geopolymer saturated kraft paper can be used as a fire and chemical resistant overlay in the building materials industry. Utilizing a non-metakaolin-containing geopolymer formula, the small particle size of the resultant slurry can penetrate the core of raw kraft paper. Geopolymer saturated kraft paper can be ceramic in nature in terms of mechanical and chemical properties, offering smooth, scratch-resistant surface for composites with the additional advantage of producing no hazardous emissions like its traditional counterparts.

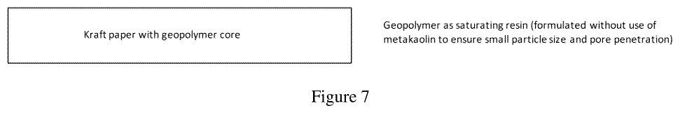

FIG. 7 depicts an illustrative view of a geopolymer saturated kraft paper composition. The geopolymer composition can include a metakaolin; an alkali silicate in a solvent; and at least one filler. The composition can include an optional organic glue line. The organic glue line can include phenolic glue line. The construct does not limit the position of any particular layer for a kraft paper saturated geopolymer composition and an optional organic glue line. The geopolymer saturated kraft paper composition and an optional organic glue line can be either in top, or bottom layers.

In some embodiments, a geopolymer saturated kraft paper composition, can include an impregnated and/or saturated kraft paper; and a geopolymer composition, wherein the geopolymer composition can include a metakaolin; an alkali silicate in a solvent; and at least one filler.

In one embodiment, the composition can include an optional organic glue line.

In another embodiment, the organic glue line can include phenolic glue line.

In further embodiments, a method for preparing a geopolymer saturated kraft paper composition, can include placing a geopolymer composition into a large container; passing a raw kraft paper through the geopolymer composition; providing an A-pass treatment to the mixture; and curing the geopolymer-treated kraft paper in an oven at 80-90° C. for 1 minute to 5 hours to produce the geopolymer saturated kraft paper composition.

In other embodiments, a composite product, can include a plurality of substrates; an impregnated and/or saturated kraft paper; and at least cured geopolymer composition, wherein the geopolymer composition can include a metakaolin; an alkali silicate in a solvent; and at least one filler.

### IX. Three-Layered Composite Products (Two Geopolymer Layers—Same or Different and Wood Substrates)

The invention provides a geopolymer composite material for use as an internal/external building material. The composite includes a wood substrate (craft wood, particle board, plywood, oriented strand board, medium density fiberboard, etc) with a geopolymer coating or paint. Before curing of the geopolymer coating or paint, a secondary, viscous coating containing larger aggregates, fillers, tints, etc, was applied and cured simultaneously for maximum adhesion. This composite can allow for the intermediate geopolymer coating to act as an adhesive by filling the pores of the wood substrate and creating a mechanical bond between it and the external geopolymer finish. The external geopolymer coating can also act as an aesthetic finish for the composite, which can be tailored to customer specifications in terms of color, stone type, etc while maintaining FR and chemical properties of aforementioned embodiments.

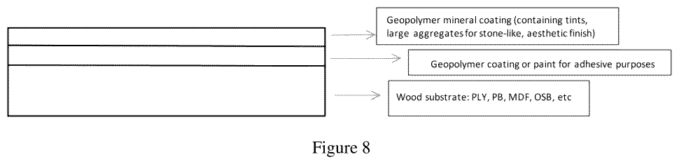

FIG. 8 depicts an illustrative view of a three-layered composite products of a plurality of wood substrates; a first geopolymer composition; and a second geopolymer composition. The first geopolymer composition or the second geopolymer composition can include a metakaolin; an alkali silicate in a solvent; and at least one filler. The construct does not limit the position of any particular layer for a wood substrate; a first geopolymer composition or a second geopolymer composition. The first geopolymer composition or the second geopolymer composition and wood substrate can be either in top, middle or bottom layers.

In some embodiments, a composition, can include a plurality of wood substrates; a first geopolymer composition; and a second geopolymer composition, wherein the first geopolymer composition or the second geopolymer composition can include a metakaolin; an alkali silicate in a solvent; and at least one filler.

In one embodiment, the first geopolymer composition and the second geopolymer composition are different.

In another embodiment, the first geopolymer composition and the second geopolymer composition are same.

In one embodiment, the first geopolymer composition or the second geopolymer composition further comprise a dye or a pigment.

In another embodiment, the first geopolymer composition or the second geopolymer composition provide an aesthetic or a decorative appearance.

In further embodiments, a method for preparing a three-layered composite product, can include applying a first geopolymer composition via roller, sprayer, or curtain coater onto a wood substrate; applying a second geopolymer composition via bird blade, or slot die coater onto the first geopolymer composition; and curing the composition in an oven at 80-90° C. for 1 minute to 5 hours to produce the three-layered composite product.

In other embodiments, a three-layered composite product, can include a plurality of wood substrates; at least cured a first geopolymer composition; and at least cured a second geopolymer composition, wherein the first geopolymer composition or the second geopolymer composition can include a metakaolin; an alkali silicate in a solvent; and at least one filler.

### X. Three-Layered Composite Products (Geopolymer Saturated Kraft Paper, Geopolymers and Wood Substrates)

The invention provides a geopolymer composite material for use as a low pressure laminate. Utilizing either a geopolymer-saturated kraft paper or melamine sheet, a geopolymer adhesive can be used to bind the overlay to a wood substrate (craft wood, particle board, medium density fiberboard). The LPL composite can be used for vertical surfaces, office furniture, and shelves.

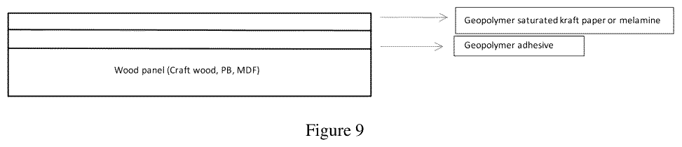

FIG. 9 depicts an illustrative view of a three-layered composite products of a plurality of wood substrates; a geopolymer saturated with kraft paper or melamine sheet; and a geopolymer composition. The geopolymer composition can include a metakaolin; an alkali silicate in a solvent; and at least one filler. The construct does not limit the position of any particular layer for a wood substrate; a geopolymer composition and a geopolymer saturated with kraft paper or melamine sheet. The geopolymer saturated with kraft paper or melamine sheet or the geopolymer composition or wood substrate can be either in top, middle or bottom layers.

In some embodiments, a composition, can include a plurality of wood substrates; a geopolymer saturated with kraft paper or melamine sheet; and a geopolymer composition, wherein the geopolymer composition can include a metakaolin; an alkali silicate in a solvent; and at least one filler.

In further embodiments, a method for preparing a three-layered composite product, can include applying a geopolymer composition via curtain coater, dip coating, metering rod, or slot die coater onto a wood substrate; placing a geopolymer composition into a large container; passing a raw kraft paper or melamine sheet through the geopolymer composition; providing an A-pass treatment to the mixture to produce a geopolymer saturated with kraft paper or melamine sheet; placing the geopolymer saturated with kraft paper or melamine sheet onto geopolymer composition coated wood substrate; and pressing the mixture hot to adhere together to produce the three-layered composite product.

In other embodiments, a three-layered composite product, can include a plurality of wood substrates; a geopolymer saturated with kraft paper or melamine sheet; and at least cured geopolymer composition, wherein the geopolymer composition can include a metakaolin; an alkali silicate in a solvent; and at least one filler.

### XI. High Pressure Laminate Composite Products

The invention provides a geopolymer composite material for use as a high pressure laminate (HPL). Utilizing unique geopolymer formula, multiple sheets of geopolymer-saturated paper can be pressed together at high pressure to form a single composite. The HPL composite can be bonded to a backing (MDF, craft wood, PB—all of which can be fabricated with geopolymer,) for use in horizontal and/or vertical surfaces, counter tops, benchtops, and tables as a high impact, chemically resistant, fire resistant surface.

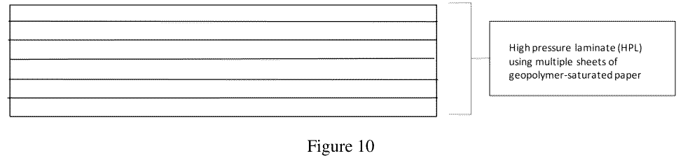

FIG. 10 depicts an illustrative view of a high pressure laminate composite product of multi-layered sheets of geopolymer saturated kraft paper pressed together at a high pressure. The geopolymer composition can include a metakaolin; an alkali silicate in a solvent; and at least one filler. The construct has geopolymer saturated kraft paper sheets from about 1 sheet to about 1000 sheets.

In some embodiments, a method for preparing a high pressure laminate composite product, can include placing a geopolymer composition into a large container; passing a raw kraft paper through the geopolymer composition; providing an A-pass treatment to the mixture; and curing the geopolymer-treated kraft paper in an oven at 80-90° C. for 1 minute to 5 hours; and pressing together multi-layered sheets of geopolymer saturated kraft paper at high pressure of about 500 psi to about 2000 psi to produce the high pressure laminate composite product.

In other embodiments, a high pressure laminate composite product, can include a plurality of multi-layered sheets of geopolymer saturated kraft paper pressed together at a high pressure of about 500 psi to about 2000 psi to produce the high pressure laminate composite product.

In certain embodiments, the number of sheets of geopolymer saturated kraft paper vary from about 1 sheet to about 1000 sheets.

In further embodiments, the pressure varies from about 500 psi to about 2000 psi.

### XII. Industrial Applications

The present invention is about specialty product(s) that are based on “hybrid technology,” which is a combination of various tailor made “geopolymers” with existing adhesives, overlays, coatings, and paint technologies along with various substrates. The compositions and composite products prepared from geopolymer compositions of the present invention offer several industrial applications including, but not limited to, fire retardant wood-based composite construct and panels, fiberglass mat for roofing shingles, fiber reinforced geopolymers (a replacement for traditional formaldehyde or petro chemical based fiber reinforced plastics), glass reinforced facer mat, slit ribbons for tube and core manufacturing, rigid & thermal roofing underlayment, molded and/or extruded products such as refractory bricks and custom molded composites for aerospace and automotive applications, saturation and/or coating of paper and other carriers for use as an overlay in the lamination process, use as caulks, paints, and adhesives, 3D printed products (including specialty parts and 3D printed home applications), and oil-field application in the form of water, gas, oil, and sand control and/or as an acidizing diverter.

Further, the present invention displays major benefits and vital utility in major industrial fields, which include, but not limited to, 1) Fire retardant (FR) capabilities will be greatly increased based on inorganic structure of geopolymer component. 2) Achieved optimal surface sealing that in turn results in reduced/no flame spread on the surface and increased resistance to scratching. 3) Most FR additives reduce end product mechanical strength when used in combination with an adhesive technology. Geopolymer binder plus filler of choice offers to achieve equivalent or better internal bond strength and modulus of rupture while exhibiting faster cure speeds and degree of cure with lower formaldehyde emissions. 4) The new geopolymer binder plus lignosulfonate and/or polyol stabilizer binder systems can be used as the novel no emissions/no-added formaldehyde resin system that performs better than incumbent technology. 5) The geopolymer-based material can potentially be a good moisture barrier. 6) Geopolymer compositions offer high level of chemical resistance which can be used for industrial/chemical storage tank coatings and offer increased FR benefits to sequestered volatile waste.

Additionally, the combination of unique geopolymer formulation (that includes filler(s) of choice) by itself and in combination with an adhesive(s) (both thermoset and thermoplastic), coating(s) (both thermoplastic and thermoset) and paint(s) (both thermoplastic and thermoset) along with a substrate (such as fiberglass, carbon fiber, cellulose, wood etc) that exhibited unique and drastically improved finished product properties with no emissions or zero emissions with significantly improved FR characteristics.

Additional applications of the present invention include, but not limited to, kiln furniture, fireplace/furnace/chimney/wood-fired oven lining, building material for external and internal applications, building materials for fire-resistant structures, insulation materials, passive cooling systems, benchtops, countertops, cabinetry, doors, flooring, shelving, and tables.

### EXAMPLES

To provide a better understanding of the foregoing discussion, the following non-limiting examples are provided. Although the examples may be directed to specific embodiments, they are not to be viewed as limiting the invention in any specific respect.

### Example 1: General Procedure for the Preparation of Geopolymer Composition

Metakaolin was measured into a stainless steel planetary mixing bowl at ambient temperature (app 22° C.). Alkali silicate solution was then added to metakaolin. The mixture was stirred approximately 5 minutes at medium speed to initiate geopolymer reaction. Stirring was temporarily stopped to add filler of choice. Stirring was resumed at low to medium speed for another 5-10 minutes to ensure slurry is homogenous.

For formulations containing fumed silica, the initial binder slurry must be stirred longer (app 15 min) to ensure sufficient time for reaction of raw materials. Premature addition of fumed silica will disrupt the kinetics of the geopolymer reaction by introducing more silicate anion into the mixture.

### Example 2: Preparation of Potassium Geopolymer Composition with Feldspar Filler (42 Wt %)

Metakaolin was measured into stainless steel planetary mixing bowl. Potassium silicate solution was measured into disposable plastic cup. Potassium silicate solution was poured into mixing bowl and briefly stirred with rubber spatula to wet ingredients. The mixture was stirred with whisk attachment for 15 minutes on medium speed to start geopolymer reaction. Feldspar filler (42 wt %) was added to the mixture. The mixture was stirred for 5-10 minutes or until homogeneous. Mixture was then poured into pre-greased silicone molds on a vibrating table to eliminate air bubbles. Two sets of 4 samples were prepared to cure at different time points. Molds were covered with plastic sheeting to prevent water loss and placed in oven at 80° C. Samples taken from the oven at 3.5, 4, and 4.5 hours to evaluate time vs. cure behavior. After removing from the oven, samples were allowed to cool for 30 minutes before de-molding. Samples were evaluated with 3-point bend test.

Table 1 shows potassium geopolymer composition containing 42 wt. % of feldspar filler.

TABLE 1
MH03222022-1

| | Reagent Name \| | | | Total | Amount | Amount |
|---|---|---|---|---|---|---|
| Reagent | Supplier | Lot # | Composition notes | Wt % | needed (g) | used (g) |
| Potassium silicate | KASIL 6 (adjusted) \| | C071521K6 \| | 65.7% H₂O, SiO₂:K₂O = 1.7 | 39.9 | 300 | 300 |
| solution | PQ Corp | MH01242022 | | | | |
| Metakaolin | MetaMax \| BASF | 10205G | 45.9% Al₂O₃ | 17.7 | 133 | 133.2 |
| Feldspar | Minspar250 | | 67.9% SiO₂, 19.1% Al₂O₃ | 42.4 | 318.7 | 318.6 |
| | | | (90% feldspar, 10% quartz) | | | |
| Water | Water \| MON tap | | | 10 (added water) | 83.5 | 83.4 |

33.6% water content = 66.4% NV

Table 2 shows potassium geopolymer composition containing 42 wt. % of feldspar filler.

TABLE 2

| | Reagent | | | Composition | | Amount | Amount |
|---|---|---|---|---|---|---|---|
| Reagent | Name | Supplier | Lot # | Notes | Wt % | Needed (g) | Used (g) |
| Potassium | KASIL 6 | PQ | MH03222022 | 65.7% H2O, | 39.84462 | 215 | 215.4 |
| silicate | adjusted | | | SiO2:K2O = | | | |
| solution | | | | 1.7 | | | |
| Metakaolin | MetaMax | BASF | 10205G | 45.9% Al2O3 | 17.75805 | 96 | 96 |
| Feldspar | Minspar250 | Imerys | | | 42.39734 | 229 | 229.7 |
| Water | | MON tap | | +10% for | | 60 | 60.1 |
| | | | | viscosity | | | |

### Example 3: Preparation of Potassium Geopolymer Composition with Feldspar Filler (10 Wt %)

Metakaolin was measured into stainless steel planetary mixing bowl. Potassium silicate solution was measured into disposable plastic cup. Potassium silicate solution was poured into mixing bowl and briefly stirred with rubber spatula to wet ingredients. The mixture was stirred with whisk attachment for 15 minutes on medium speed to start geopolymer reaction. Feldspar filler (10 wt %) was added to the mixture. The mixture was stirred for 5-10 minutes or until homogeneous. Mixture was then poured into pre-greased silicone molds on a vibrating table to eliminate air bubbles. Two sets of 4 samples were prepared to cure at different time points. Molds were covered with plastic sheeting to prevent water loss and placed in oven at 80° C. Samples taken from the oven at 3.5, 4, and 4.5 hours to evaluate time vs. cure behavior. After removing from the oven, samples were allowed to cool for 30 minutes before de-molding. Samples were evaluated with 3-point bend test.

Table 3 shows potassium geopolymer composition containing 10 wt. % of feldspar filler.

TABLE 3

| | Reagent | | | Composition | | Amount | Amount |
|---|---|---|---|---|---|---|---|
| Reagent | Name | Supplier | Lot # | Notes | Wt % | Needed (g) | Used (g) |
| Potassium | KASIL 6 | PQ | MH03222022 | 65.7% H2O, | 62.25203 | 436 | 436.2 |
| silicate | adjusted | | | SiO2:K2O = | | | |
| solution | | | | 1.7 | | | |
| Metakaolin | MetaMax | BASF | 10205G | 45.9% Al2O3 | 27.74368 | 194 | 194.4 |
| Feldspar | Minspar250 | Imerys | | | 10.00428 | 70.1 | 74.9 |

### Example 4: General Procedure for Making Wood Composite Product

Potassium geopolymer binder composition with 2-10 wt. % fumed Silica (SiO₂) was coated on wood substrate using either a grooved roller or a paint roller. For single-sided coats, the coated wood substrate was cured in an 80° C. oven for 15 minutes. For double-sided coats, the wood substrate was first cured for 5 minutes at 80° C. to eliminate tack, and then cured for 15 minutes after coating application on the opposite side. For double coats on a single side of the wood substrate, the substrate was let to stand at ambient temperature for 10-15 minutes after the first coat to eliminate tack. After application of the second coat, the wood substrate was then cured for 15 minutes at 80° C.

### Example 5: Particle Board Fabrication

Wood furnish was loaded into a blender. Geopolymer composition was applied to the wood furnish via atomized spray. The wood furnish was placed in a 12″×12″ mold via felting process to form a molded panel. The molded panel was unmolded via pre-pressing with body weight pressure to form a pre-press panel. Wax paper was placed over the pre-pressed panel in order to prevent sticking to the heated press. The panel was cured at a temperature of about 180° F. to about 300° F. for about 5 minutes to about 1 hour and at a pressure of about 1 psi to about 500 psi. The warm panel was pressed together under 18-50 lb weights via hot stacking process. The panel was heated at a temperature of about 180° F. in an oven for about 1 hour to about 4 hours to produce the particle board.

### Example 6: Plywood Fabrication

Geopolymer composition was applied to a plywood veneer on both faces via roller, wire round metering rod, slot die coater, doctor blade, or paint brush. The veneer faces were placed together in perpendicular fashion with respect to wood grain. The veneer faces were pressed at a temperature of about 180° F. to about 250° F. for about 5 minutes to about 30 minutes at a pressure of about 1,500 psi to form a plywood construct. The plywood construct was removed from the pressed condition. The plywood construct was placed under 80 lb weight for 48 hours at room temperature to form the plywood.

### Example 7: Preparation of Refractory Bricks

Geopolymer composition was applied to a plurality of brick substrate to form a mixture. The mixture was stirred for about 2 minutes to about 30 minutes until homogeneous. The mixture was then poured into a mold and pressed upward at a pressure of about 6000 psi to form a brick. The brick was cured at a temperature of about 90° C. to form the refractory brick.

### Example 8: Preparation of Fire Retardant Construct Composition

Vapor barrier overlay (VBO) was placed into a mold (with specified dimensions' dependent on end application). Geopolymer composition (a metakaolin; an alkali silicate in a solvent; and at least one filler) was poured into the mold. The composition was cured in an oven at 80° C. for 1 hour to 5 hours. The composition was removed from the oven, allowed to cool to room temperature, then un-molded to form the fire retardant construct composition.

### Example 9: Preparation of Geopolymer-based Molded Product

Geopolymer composition was injected or poured into a mold of any shape or size containing blowing agent(s). The mixture was cured at a temperature of about 80° C. for about 1 hour to about 4 hours until it solidified to form a geopolymer-based molded product.

### Example 10: Preparation of Potassium Geopolymer Composition with Calcium Carbonate Filler (5 wt %)

Table 4 shows potassium geopolymer composition containing 5 wt. % of calcium carbonate filler.

TABLE 4

| | Reagent | | | Composition | | Amount | Amount |
|---|---|---|---|---|---|---|---|
| Reagent | Name | Supplier | Lot # | Notes | Wt % | Needed (g) | Used (g) |
| Potassium | KASIL 6 | PQ | C071512K6 | 65.7% H₂O, | 66.72461 | 400 | 400 |
| silicate | (adjusted) | | (MH01242022, | SiO₂:K₂O = | | | |
| solution | | | SL030922-3) | 1.7 | | | |
| Metakaolin | MetaMax | BASF | 1025G | 45.9% Al₂O₃ | 29.28032 | 178.2197 | 178.2 |
| Calcium | CaCO₃ | LabChem | L256-04 | | 4.995071 | 30.43261 | 30.4 |
| Carbonate | | | | | | | |

### Example 11: Preparation of Potassium Geopolymer Composition with Calcium Carbonate Filler (15 wt %)

Table 5 shows potassium geopolymer composition containing 15 wt. % of calcium carbonate filler.

TABLE 5

| | Reagent | | | Composition | | Amount | Amount |
|---|---|---|---|---|---|---|---|
| Reagent | Name | Supplier | Lot # | Notes | Wt % | Needed (g) | Used (g) |
| Potassium | KASIL 6 | PQ | MH01242022, | 65.7% H2O, | 58.80278 | 200 | 200 |
| silicate | adjusted | | SL030922-3 | SiO2:K2O = | | | |
| solution | | | | 1.7 | | | |
| Metakaolin | MetaMax | BASF | 10205G | 45.9% Al2O3 | 26.19664 | 89.1 | 89.1 |
| Calcium | CaCO3 | LabChem | L256-04 | | 15.00059 | 51 | 51.02 |
| Carbonate | | | | | | | |

Table 6 shows potassium geopolymer composition containing 5.1 wt. % of calcium carbonate filler.

TABLE 6

| | Reagent | | | Composition | | Amount | Amount |
|---|---|---|---|---|---|---|---|
| Reagent | Name | Supplier | Lot # | Notes | Wt % | Needed (g) | Used (g) |
| Potassium | KASIL 6 | PQ | MH03222022-1 | 65.7% H2O, | 63.78568 | 400 | 400 |
| silicate | adjusted | | | SiO2:K2O = | | | |
| solution | | | | 1.7 | | | |
| Metakaolin | Metastar502 | Imerys | | 45% Al2O3 | 31.04768 | 195 | 194.7 |
| | HP | | | | | | |
| Calcium | CaCO3 | LabChem | L256-04 | | 5.16664 | 31.3 | 32.4 |
| Carbonate | | | | | | | |

### Example 12: Preparation of Potassium Geopolymer Composition with Calcium Carbonate Filler (2.6 wt %)

Table 7 shows potassium geopolymer composition containing 2.6 wt. % of calcium carbonate filler.

TABLE 7

| | Reagent Name \| | | | Total | Amount | Amount |
|---|---|---|---|---|---|---|
| Reagent | Supplier | Lot # | Composition notes | Wt % | needed (g) | used (g) |
| Potassium silicate | KASIL 6 (adjusted) \| | C071521K6 \| | 65.7% H₂O, | 67.4 | 200 | 200.1 |
| solution | PQ Corp | MH03222022-1 | SiO₂:K₂O = 1.7 | | | |
| Metakaolin | MetaMax \| BASF | 10205G | 45.9% Al₂O₃ | 30.0 | 89.1 | 89.1 |
| Calcium carbonate | LabChem | L256-04 | | 2.6 | 7.6 | 7.6 |

### Example 13: Preparation of Three-Layered Composite Product (Geopolymers, Fiberglass/Cellulose/Kraft Paper, Wood Substrates)

Fiberglass sheet or cellulose sheet or kraft paper was placed or rolled onto a wood substrate. Geopolymer composition was then applied on the top layer via curtain coater, dip coating, metering rod, or slot die coating. The composition was cured as coated in an oven at 80-90° C. for 1 minute to 4 hours to produce the three-layered composite product

### Example 14: Preparation of Three-Layered Composite Product (Geopolymers, High Density Kraft Paper, Organic Glue Line)

High density kraft paper was coated with geopolymer via wire wound metering rod on external face. Internal face was coated with an organic glue line for later adhesion to substrate via hot pressing.

### Example 15: Preparation of Geopolymers Saturated Kraft Paper Composition

Geopolymer composition was placed into a large container. Raw kraft paper was passed through the geopolymer composition. A-pass treatment was provided to the mixture. The geopolymer-treated kraft paper was cured in an oven at 80-90° C. for 1 minute to 5 hours to produce the geopolymer saturated kraft paper composition.

### Example 16: Preparation of Three-Layered Composite Product (Two Geopolymer Layers—Same or Different and Wood Substrates)

The first geopolymer composition was applied via roller, sprayer, or curtain coater onto a wood substrate. The second geopolymer composition was applied via bird blade, or slot die coater onto the first geopolymer composition. The composition was cured in an oven at 80-90° C. for 1 minute to 5 hours to produce the three-layered composite product.

### Example 17: Preparation of Three-Layered Composite Product (Geopolymer Saturated Kraft Paper or Melamine Sheet, Geopolymers and Wood Substrates)

Geopolymer composition was applied via curtain coater, dip coating, metering rod, or slot die coater onto a wood substrate. Another geopolymer composition was placed into a large container. A raw kraft paper or melamine sheet was passed through the geopolymer composition. An A-pass treatment was provided to the mixture to produce a geopolymer saturated with kraft paper or melamine sheet. The geopolymer saturated with kraft paper or melamine sheet was placed onto geopolymer composition coated wood substrate. The mixture was pressed hot to adhere together to produce the three-layered composite product.

### Example 18: Preparation of High Pressure Laminate Composite Product

Geopolymer composition was placed into a large container. Raw kraft paper was passed through the geopolymer composition. A-pass treatment was provided to the mixture. The geopolymer-treated kraft paper was cured in an oven at 80-90° C. for 1 minute to 5 hours to produce the geopolymer saturated kraft paper sheets. Multi-layered sheets of geopolymer saturated kraft paper were pressed together at high pressure the pressure varies of about 500 psi to about 2000 psi to produce the high pressure laminate composite product.

While in the foregoing specification this invention has been described in relation to certain embodiments thereof, and many details have been put forth for the purpose of illustration, it will be apparent to those skilled in the art that the invention includes additional embodiments and that certain of the details described herein can be varied considerably without departing from the basic principles of the invention. Although we have described the preferred embodiments for implementing our invention, it will be understood by those skilled in the art to which this disclosure is directed that modifications and additions may be made to our invention without departing from its scope.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

We claim:

1. A refractory brick composition, comprising:
a plurality of brick substrates; and
a geopolymer composition, wherein the geopolymer composition comprises a metakaolin; a metal silicate in a solvent; and at least one filler.

2. The refractory brick composition of claim 1, wherein the geopolymer composition comprises a metal geopolymer composition.

3. The refractory brick composition of claim 2, wherein the metal is selected from the group consisting of lithium, sodium, potassium, rubidium, cesium, calcium, magnesium, and mixtures thereof.

4. The refractory brick composition of claim 2, wherein the metal geopolymer composition is potassium metal geopolymer composition, sodium metal geopolymer composition, calcium metal geopolymer composition, magnesium metal geopolymer composition or combinations thereof.

5. The refractory brick composition of claim 1, wherein the filler is selected from the group consisting of multi-purpose sand, titanium dioxide, calcium carbonate, silicon dioxide, lignosulfonate, powdered graphite, cristoballite, feldspar, wollostonite, perlite, other aluminosilicate derivates, melamine, bisphenol A, sodium sulfate, sodium bicarbonate, hexamine, soda ash, sodium meta bisulfite, ammonium sulfate, elvamide, ethylene glycol, guar gum, stannous chloride, glycerin, paraformaldehyde, wheat/gluten flour, lithium carbonate, ammonium acetate, molasses, polyvinyl butural, polyvinyl alcohol, polyvinyl acetate, caprolactam, carboxy methyl cellulose (CMC), and mixtures thereof.

6. The refractory brick composition of claim 1, wherein two or more fillers are present.

7. The refractory brick composition of claim 1, further comprising an additive.

8. The refractory brick composition of claim 7, wherein the additive comprises an aldehyde-based resin.

9. The refractory brick composition of claim 8, wherein the aldehyde-based resin is selected from the group consisting of a phenol-formaldehyde resin, a urea-formaldehyde resin, a melamine-formaldehyde resin, a melamine-urea-formaldehyde resin, a phenol-melamine-formaldehyde resin, a resorcinol-formaldehyde resin, or a phenol-resorcinol-formaldehyde resin, and combinations thereof.

10. A method for preparing a refractory brick, comprising:
loading a plurality of brick substrates;
applying a geopolymer composition of claim 1 to the brick substrates to form a mixture;
stirring the mixture for about 2 minutes to about 30 minutes until homogeneous;
pouring the mixture into a mold;
pressing upward at a pressure of about 6000 psi to form a brick;
curing the brick at a temperature of about 90° C. to form the refractory brick.

11. A refractory brick product, comprising:
a plurality of brick substrates; and
at least cured geopolymer composition of claim 1.

12. A composition, comprising:
a blowing agent; and
a geopolymer composition, wherein the geopolymer composition comprises a metakaolin; an alkali silicate in a solvent; and at least one filler.

13. The composition of claim 12, wherein the blowing agent is selected from the group consisting of hydrogen peroxide, sodium perborate, azodicarbonamide, azo-bis-isobutyronitrile, diphenylene oxide disulphohydrazine, pyrocarbonic esters, acetonitrile, butyronitrile, isobutyronitrile, acetaldoxime, butyraldoxime or isobutyaldoxime, and mixtures thereof.

14. The composition of claim 12, wherein the geopolymer composition is an alkali metal geopolymer composition.

15. The composition of claim 14, wherein the alkali metal geopolymer composition is potassium metal geopolymer composition, sodium metal geopolymer composition or combinations thereof.

16. A molded composite product, comprising:
a plurality of substrates;
a blowing agent; and
at least cured geopolymer composition of claim 12.

17. A composition, comprising:
a plurality of wood substrates;
a first geopolymer composition; and
a second geopolymer composition, wherein the first geopolymer composition or the second geopolymer composition comprise a metakaolin; an alkali silicate in a solvent; and at least one filler.

18. The composition of claim 17, wherein the first geopolymer composition and the second geopolymer composition are same or different.

19. The composition of claim 17, wherein the first geopolymer composition or the second geopolymer composition further comprise a dye or a pigment and provide an aesthetic or a decorative appearance.

20. A three-layered composite product, comprising:
a plurality of wood substrates;
at least cured a first geopolymer composition of claim 17; and
at least cured a second geopolymer composition of claim 17.
